(19) United States
(12) Patent Application Publication
(10) Pub. No.: US 2023/0133756 A1
(43) Pub. Date: May 4, 2023

(54) SAFE DELIVERY CONTAINER, AND SYSTEM AND METHOD THEREOF

(71) Applicant: VEROFAX LIMITED, Abu Dhabi (AE)

(72) Inventor: Wassim MERHEBY, Abu Dhabi (AE)

(21) Appl. No.: 17/918,561

(22) PCT Filed: Apr. 15, 2021
(86) PCT No.: PCT/IB2021/053126

§ 371 Date: Oct. 12, 2022

Related U.S. Application Data
(60) Provisional application No. 63/011,081, filed on Apr. 16, 2020.

(51) Int. Cl. A47G 29/14; G07C 9/00

(52) U.S. Cl. CPC A47G 29/141; G07C 9/00896; G07C 9/00309; G07C 9/00563; G07C 2009/0092; G07C 2009/00412; A47G 2029/146; A47G 2029/149

(57) ABSTRACT

A safe delivery container, system and method which permits tracking of the state of the container and controlled release of its contents. Determination of the state of the container is preferably provided according to a plurality of sensors, including without limitation a temperature sensor, GPS tracking device, accelerometer, gyroscope, and an IMU. Tracking of the state of the container is preferably supported through a communication module which may for example comprise a SIM card. Such a communication module preferably enables the sensor signals to be transmitted to a remote location. Alternatively and/or additionally, communication of such sensor signals may occur when the container is brought into communication contact with each of a plurality of local communication devices. Upon receipt of such state information for the container, optionally and preferably the state information is written to a distributed ledger technology (DLT) such as for example the blockchain.

### FIELD OF THE INVENTION

The present invention is of a safe delivery container, and system and method thereof, and in particular, to such a safe delivery container, system and method which permits tracking of the state of the container and controlled release of its contents.

### BACKGROUND OF THE INVENTION

Global manufacturing and transport has enabled a wide variety of goods to be available internationally. Unfortunately, it has also introduced security and fraud problems, as many pharmaceutical and other goods have turned out to be counterfeit. In the case of pharmaceuticals, counterfeit goods could be life threatening. Current systems have difficulty accurately tracing such goods from manufacturing facility to end consumer. In other cases, such as that of opiate pain killers, traceability is desired to determine which patients are receiving such drugs and to at least reduce the illegal sale of such drugs.

Agriculture is another area in which accurate end to end traceability is desired. In certain food borne disease outbreaks in the US, for example, consumers were told to discard certain products such as romaine lettuce, regardless of origin, because it was not possible to trace the outbreak to a particular region, let alone a particular agriculture producer.

Unfortunately no accurate and simple to use end to end tracing system is currently available.

### BRIEF SUMMARY OF THE INVENTION

The present invention, in at least some embodiments, is of a safe delivery container, system and method which permits tracking of the state of the container and controlled release of its contents. Determination of the state of the container is preferably provided according to a plurality of sensors, including without limitation a temperature sensor, GPS tracking device, accelerometer, gyroscope, and an IMU. Tracking of the state of the container is preferably supported through a communication module which may for example comprise a SIM card. Such a communication module preferably enables the sensor signals to be transmitted to a remote location. Alternatively and/or additionally, communication of such sensor signals may occur when the container is brought into communication contact with each of a plurality of local communication devices, such as for example and without limitation a mobile communication device and/or a near field communication (NFC) device.

Upon receipt of such state information for the container, optionally and preferably the state information is written to a distributed ledger technology (DLT) such as for example the blockchain.

Controlled release of the contents is preferably provided through an electronic smart lock. The electronic smart lock preferably only opens upon receipt of a signal indicating that an authorized recipient wishes to access the contents. Such a signal may be provided for example through one or more of an NFC ID card reader, biometric sensor, communication with a smart device, entry of a code and/or remote transmission of an unlocking signal.

The biometric sensor may comprise for example one or more of fingerprint, palmprint, voice analysis, retinal scan, iris scan and/or facial identification. Optionally each container has a unique serialized QR code. The secure container preferably supports contactless delivery. This is accomplished through validation, for example by scanning the QR code on the box, through an NFC card reader signal, biometric sensor signal, communication with a smart device, entry of a code and/or remote transmission of an unlocking signal. Some combination of these methods may also be used.

Without wishing to be limited by a closed list, among the advantages of the container is that whenever an unauthorized user tries to open the container, tamper with the container or move it out of a geofenced area, an alert is sent to the responsible party. Thus privacy of the products inside the box is maintained and only an authorized party may open the box and view the products inside the box.

Preferably, tracking of the state of the container is then recorded through digital certification for the container, which is saved on a distributed ledger such as the blockchain. Such tamperproof storage ensures verified tracing of the product throughout the supply chain with secure packaging.

Non-limiting examples of products for which such a traceable container may be used include pharmaceuticals, medical devices and other medical products; non-medical chemicals; food and beverages; cosmetics; jewelry, precious metals and gemstones; fashion, including without limitation clothing, shoes, handbags and other accessories; art, including without limitation paintings and sculpture; electronic products and parts; and spare machine parts, including without limitation automobile parts.

According to at least some embodiments, there is provided a system for providing traceability, comprising a safe delivery container with a traceable state, comprising a space for holding a product; a sensor for providing signals regarding a state of the container; a communication module for communicating said signals; and a security device for securing the container; a distributed ledger technology (DLT) for recording said state of said container; and a server for receiving such signals from said communication module and for determining said state according to said signals, and for recording said state on said DLT.

Optionally said sensor comprises one or more of a temperature sensor, GPS tracking device, accelerometer, gyroscope, and an IMU. Optionally said communication module comprises a cellular communication device. Optionally said cellular communication device comprises a SIM card.

Optionally the system further comprises a local communication device, wherein said container is brought into communication contact with said local communication device. Optionally said local communication device comprises one or more of a mobile communication device or a near field communication (NFC) device. Optionally said security device comprise an electronic smart lock. Optionally said electronic smart lock opens upon receipt of a signal indicating that an authorized recipient wishes to access said container. Optionally said signal comprises an authorization code and said security device comprises a code entry device for receiving said authorization code. Optionally said authorization code comprises an OTP (one time password). Optionally said signal comprises a remote authorization signal received through said communication module.

Optionally the system further comprises a user app and a user computational device for operating said user app, wherein said remote authorization signal is sent through said user app. Optionally said user computational device communicates with said server for determining authorization of said user app and for sending said remote authorization signal. Optionally said signal comprises an NFC ID card signal and said security device further comprises an NFC ID card reader for receiving said signal. Optionally said signal comprises a biometric signal and said security device further comprises a biometric sensor for receiving said signal. Optionally said biometric sensor comprises one or more of fingerprint, palmprint, voice analysis, retinal scan, iris scan and/or facial identification. Optionally said container comprises an external visual code and said signal comprises an authenticated scan of said external visual code. Optionally said visual code comprises a QR code. Optionally said server sets said signal and authentication. Optionally said signal and authentication is determined locally at said container, before a product is placed therein.

Optionally said container comprises a lid, a plurality of walls and a floor, wherein said space is defined by said lid, said plurality of walls and said floor; wherein said security device comprises said electronic lock for securing said lid to at least one wall. Optionally said security device comprises an identification device for generating and/or receiving said authentication signal, and said identification device is set into said lid. Optionally said lid further comprises said sensor(s) and said communication module. Optionally said lid is capable of being added to a suitable container construction comprising four walls and a floor. Optionally said lid further comprises a motherboard, wherein said identification device and a plurality of said sensors for providing signals regarding a state of the container are located on or in communication with said motherboard, said motherboard further comprising a SOC (system on chip), said SOC comprising a processor and a memory, said memory comprising a plurality of instructions for being executed by said processor and for supporting one or more functions of said container.

Optionally said DLT comprises a blockchain. Optionally said blockchain comprises Hyperledger Fabric technology.

Optionally the system further comprises a blockchain gateway, wherein said blockchain gateway is in communication with said server for reading from and writing to said blockchain. Optionally said container is directly in communication with said blockchain gateway. Optionally said blockchain further comprises a smart contract, wherein said smart contract executes if said state of said container exceeds one or more permitted boundaries. Optionally execution of said smart contract causes said server to execute an alarm. Optionally said blockchain further comprises a smart contract, wherein said smart contract executes if said state of said container stays within one or more permitted boundaries during a specified period. Optionally said specified period corresponds to shipment of a product contained within said container.

Optionally said server receives signals from said sensor and determines whether said state of said container exceeds one or more permitted boundaries. Optionally said server issues an alarm if said state of said container exceeds one or more permitted boundaries. Optionally said container comprises a processor and a memory, wherein a plurality of instructions are stored on said memory and executed by said processor; wherein execution of said instructions comprises receiving signals from said sensor and determining whether said state of said container exceeds one or more permitted boundaries. Optionally further instructions executed by said processor of said container cause an alarm to be issued if said state of said container exceeds one or more permitted boundaries.

Optionally the system further comprises a computer network and a user computational device, wherein said server is in communication with said user computational device through said network for transmitting information about said state of said container to said user computational device. Optionally said user computational device further comprises an app for receiving user instructions and/or displaying user information regarding said container and comprises a processor and a memory, said memory comprising a plurality of instructions for being executed by said processor for operating said app. Optionally said user information comprises information regarding said state of said container, delivery of said container or a combination thereof.

Optionally said server comprises a processor and a memory, said memory comprising a plurality of instructions for being executed by said processor and for executing said functions of said server. Optionally said container contains a product selected from the group consisting of pharmaceuticals, medical devices and other medical products; non-medical chemicals; food and beverages; cosmetics; jewelry, precious metals and gemstones; fashion, including without limitation clothing, shoes, handbags and other accessories; art, including without limitation paintings and sculpture; electronic products and parts; and spare machine parts, including without limitation automobile parts.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows a non-limiting, exemplary, illustrative top view of the secure container;

FIG. 2 shows a non-limiting, exemplary, illustrative front view of the secure container;

FIG. 3 shows a non-limiting, exemplary, illustrative flat view of the secure container;

FIG. 4 shows a non-limiting, exemplary, illustrative cut-away view of the lid of the secure container;

FIG. 5 shows a non-limiting, exemplary, illustrative view of a product being placed within the secure container;

FIG. 6 shows a non-limiting, exemplary, illustrative view of the secure container being locked;

FIGS. 7A and 7B show non-limiting, exemplary, illustrative systems for tracking the state of the secure container;

FIG. 8 shows a non-limiting, exemplary, illustrative analysis engine for the systems of FIGS. 7A and 7B;

FIG. 9 shows a non-limiting, exemplary, illustrative system for supporting communication with a user computational device;

FIG. 10A shows a non-limiting, exemplary, illustrative system for supporting communication with multiple devices;

FIG. 10B shows exemplary, non-limiting communication between services in such a system;

FIG. 11 shows a non-limiting, exemplary, illustrative method for communication between multiple devices;

FIG. 12 shows a non-limiting, exemplary, illustrative order display screen, in this non-limiting example for a medical product;

FIG. 13 shows a non-limiting, exemplary, illustrative registration screen;

FIG. 14 shows a non-limiting, exemplary, illustrative screen for preparing a new order;

FIG. 15 shows a non-limiting, exemplary, illustrative screen for authenticating a user; and

FIG. 16 shows a non-limiting, exemplary, illustrative screen for identifying a specific container.

### DESCRIPTION OF AT LEAST SOME EMBODIMENTS

Any suitable blockchain which involves a distributed ledger, which preferably requires some type of cryptography, more preferably a public/private key encryption system, or hash or digital signatures, may optionally be used. Once a change—such as for example tracking the state of the container and determining an updated state—is made and is written to the distributed ledger, this change is automatically securely, non-falsifiably, that is completely accurately, replicated to all network participants.

The nature of the distributed ledger is such that all parties to a transaction can see the details of the transaction and optionally further requirements for the transaction to be complete.

Such a distributed ledger would also have the advantage of fraud prevention with immutable, append-only Distributed Ledger Technology. For example, users attempting to fraudulently trade cryptocurrency units that they do not possess would be blocked.

A blockchain or blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The data records recorded in the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain. For example, in the case of cryptocurrencies, a valid transaction is one that is digitally signed, spent from a valid digital wallet and, in some cases, that meets other criteria. In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably the blockchain(s) that is/are implemented are capable of running code, to facilitate the use of smart contracts. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, buying or selling goods, whether or virtual or physical, executing transfers of goods or of rights associated with such goods, and the like.

Smart contracts may also be described as pre-written logic (computer code), stored and replicated on a distributed storage platform (eg a blockchain), executed/run by a network of computers (which may be the same ones running the blockchain), which can result in ledger updates (transfer of digital rights, etc).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin' s main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

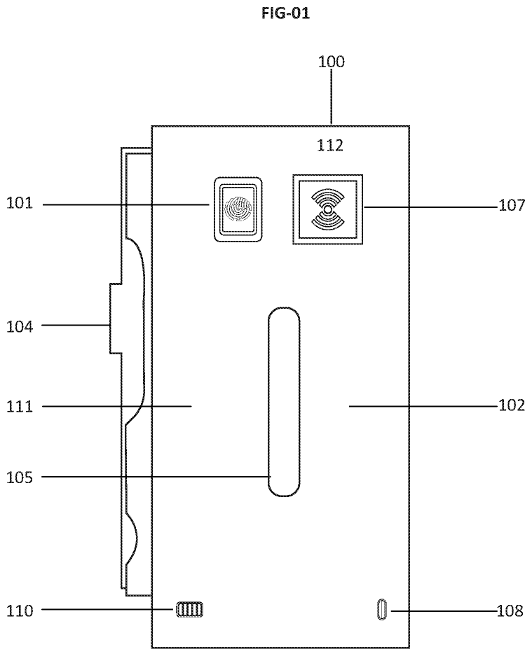

FIG. 1 shows a non-limiting, exemplary, illustrative top view of the secure container. As shown, a secure container 100 comprises a top surface 112. Embedded in, contiguous with, integrally formed with and/or attached to top surface 112 are a number of features. Preferably such features include at least a biometric identifier 101 and/or an NFC card reader 107. Optionally one of biometric identifier 101 and NFC card reader 107 is present. A handle 104 may be embedded in, contiguous with, integrally formed with and/or attached to top surface 112 to support transport of secure container 100.

Top surface 112 may also comprise a battery indicator 110, to show how much power is still available in a battery (not shown). If additional power is required for the battery, recharging is preferably supported through a charging port 108, which may for example comprise a standard USB charging mechanism.

Top surface 112 may also comprise a GPS 111 and an accelerometer 102. Accelerometer 102 may for example comprise a three axis accelerometer, with data rates from 10 Hz to 800 Hz for example. With regard to these aspects of top surface 112, top surface 112 may be formed as a lid which may be opened to access the contents of container 100. Without wishing to be limited by a closed list, one advantage of placing such components within a lid is that the rest of the container may be configured as a “dumb” or simple container. In this configuration, the majority if not all of the smart sensors and other components are placed within the “smart” lid which may then be fitted to any suitable box type configuration, preferably with four walls and a floor.

Secure container 100 preferably also comprises an electronic lock 118 to prevent unauthorized access to the contents therein. If top surface 112 forms a lid, then electronic lock 118 preferably prevents the lid from being opened without authorization, by securely locking top surface 112 to a wall of the four walls of container 100.

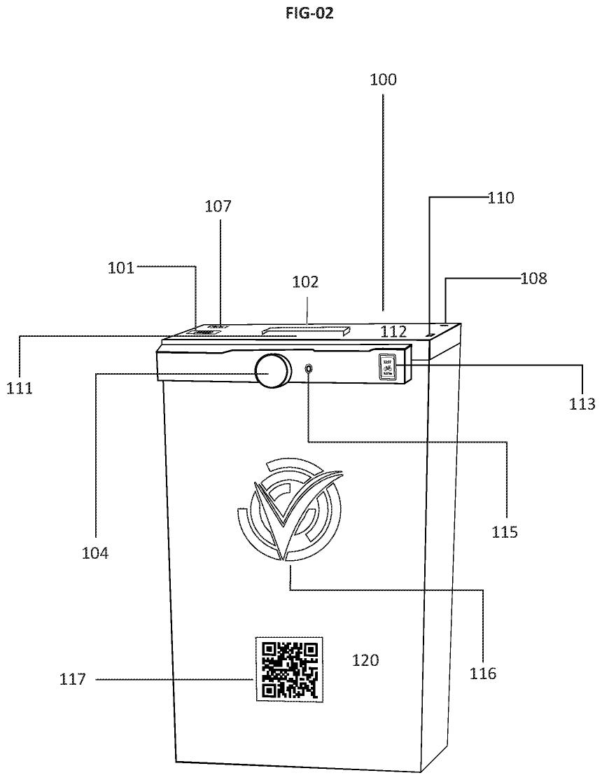

FIG. 2 shows a non-limiting, exemplary, illustrative front view of the secure container 100. Components with the same numbers as FIG. 1 have the same or at least similar function. A front wall 120 of container 100 is shown. Electronic lock 118 is shown as securely locking top surface 112, shown in this implementation as a lid, to front wall 120. Front wall 120 also preferably features a container identifier 116 and/or identifier 117. Container identifier 117 is preferably a passive identifier, such as a QR code for example, that may be read by an app or other device (not shown). Container identifier 116 is preferably an NFC tag or other suitable technology. Optionally only one of container identifier 116 or container identifier 117 is present.

A temperature sensor 115 may be present to detect an external temperature. Optionally, temperature sensor 115 is configured to detect only a temperature within container 100, or a combination of temperature readings may be taken from both within and without container 100. The temperature within container 100 may be important for protecting the contents of container 100, for example for more sensitive contents. The temperature external to container 100 may be important for protecting container 100 itself, as container 100 itself may only be able to withstand a limited temperature range for correct operation.

An activity counter 113 may be present at top surface 112 and/or front wall 120. Activity counter 113 may count the number of trips container 100 experienced during a particular period of time and/or the number of times container 100 was opened since a particular order was sent. For example, activity counter 113 may indicate the number of events which are permitted to occur during some time period before maintenance or another action is required. The time period may be an integral number of events and/or may relate to elapsed time.

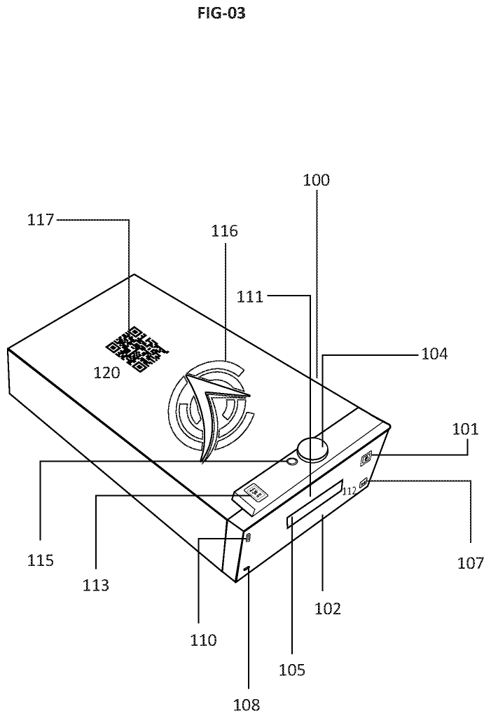

FIG. 3 shows a non-limiting, exemplary, illustrative flat view of the secure container. Components with the same numbers as in FIG. 1 or 2 have the same or at least similar function. Electronic lock 104 is shown as securing top surface 112 to front wall 120. Secure container 100 may be placed in a variety of positions during transport; for example, FIG. 2 shows an upright position while FIG. 3 shows a horizontal position.

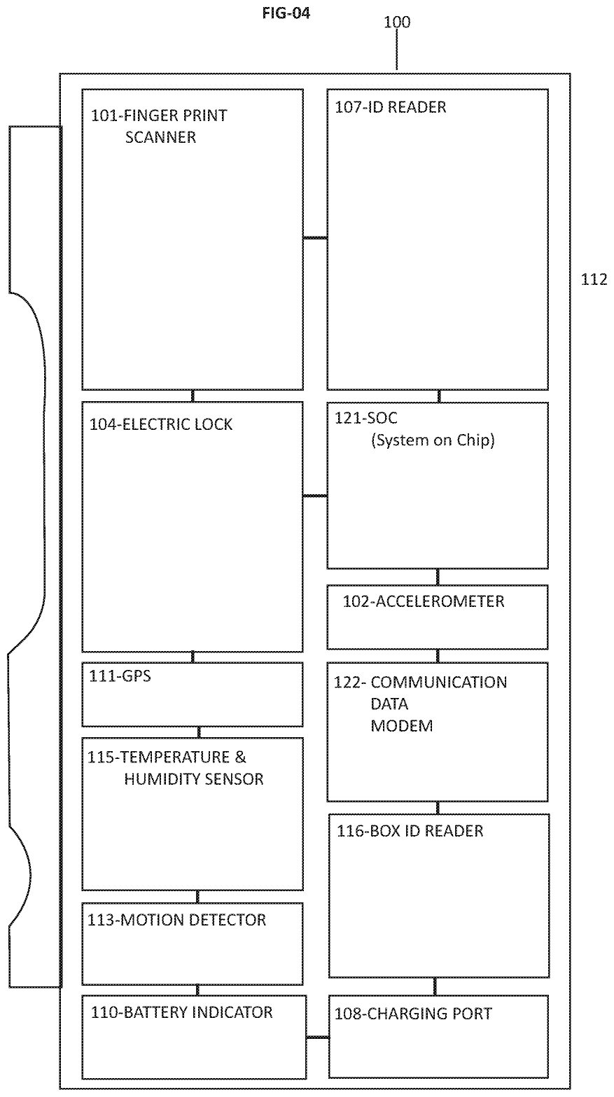

FIG. 4 shows a non-limiting, exemplary, illustrative cut-away view of the lid of the secure container. Components with the same numbers as FIGS. 1-3 have the same or similar functions. In this cut-away view, top surface 112 is assumed to be configured as a lid, with the components shown herein at least partially contained within the lid, with a cover placed over the top of the lid to cover it (not shown). This cut-away view may be described as showing a motherboard or other electronic board with components placed on such a board (not shown). The components may lie wholly under the cover placed over the top of the lid, or may lie partially under such a cover and may be partially exposed by such a cover. For example, biometric scanner 101, electronic lock 104, battery indicator 110 and charging port 108 preferably lie partially under such a cover, with at least a portion protruding out from the cover (or in the case of charging port 108, featuring a hole through the cover).

In this view, temperature sensor 115 further comprises a humidity sensor. A system on chip (SOC) 121 preferably provides a processor with memory on which instructions are stored, such that one or more instructions may be executed by the processor. For example and without limitation, one or more instructions may be executed to determine when electronic lock 104 is to be unlocked and/or the status of electronic lock 104 as locked or unlocked.

As another example, one or more instructions may be executed to obtain signals from the various sensors as shown herein. One or more instructions may be executed to transmit such signals externally from container 100, for example through a communication module 122 or communication data modem. Communication module 122 may for example comprises a cellular communication module, such as a GSM module with a SIM card (not shown). An active container identifier 116 may include a component to act as an NFC tag as shown herein. The components as shown herein may communicate for example through a suitable bus or other communication channel (not shown).

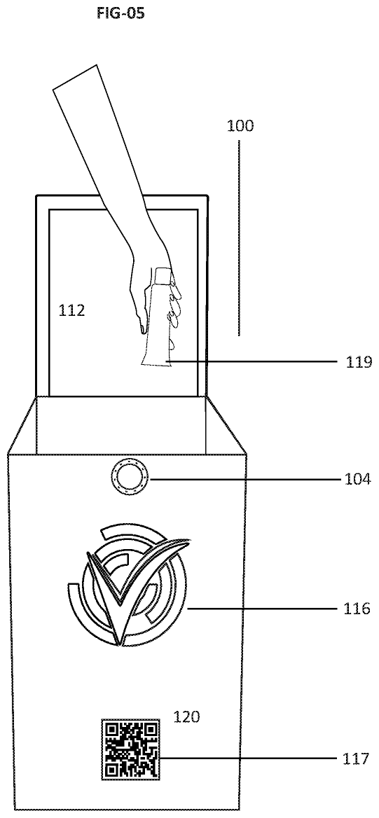

FIG. 5 shows a non-limiting, exemplary, illustrative view of a product being placed within the secure container. Components with the same numbers as FIGS. 1-4 have the same or similar functions. In this view, container 100 features top surface 112 configured as a lid, with that lid in the open position. Electronic lock 104 is shown in the open or unlocked position (although this position may not be readily visually identifiable, apart from having the lid in the open position). A product 119 is being placed within container 100. Preferably, before product 119 is placed within open container 100, the identity of the specific container is determined according to active container identifier 116 and/or passive container identifier 117.

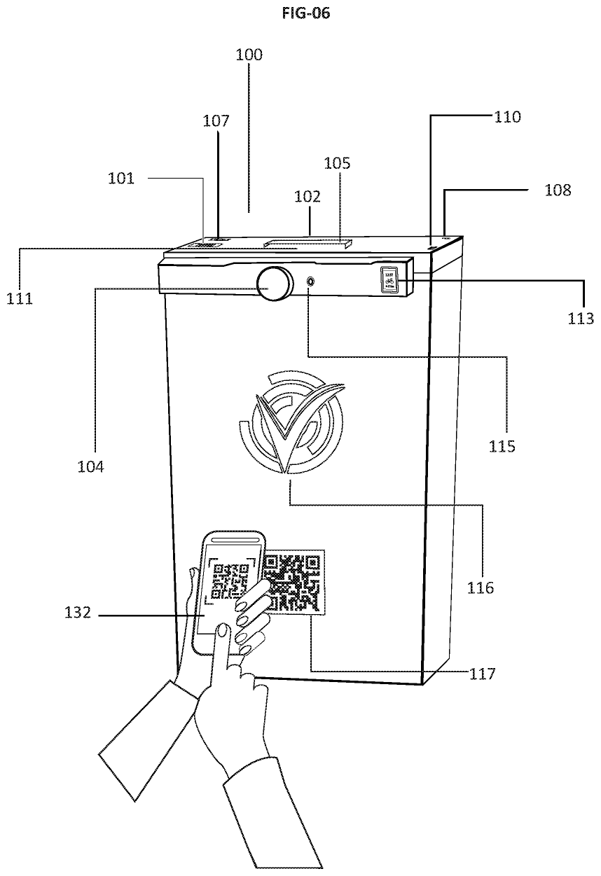

FIG. 6 shows a non-limiting, exemplary, illustrative view of the secure container in the locked configuration, which may occur for example before or after a product is placed in the secure container. Components with the same numbers as FIGS. 1-5 have the same or similar functions. In this view, an authorized user is preferably identifying container 100 through an app 132 on a computational device, shown herein without limitation as a mobile communication device such as a smart phone. As part of such a process, the authorized user may perform various actions. For example, the authorized user may lock container 100 with smart lock 104, and then initiate the process of logging container 100 (for example on a blockchain) to start the transport process. The authorized user may request container 100 to be unlocked by unlocking smart lock 104, and then placing a product within container 100 and/or withdrawing a product from container 100.

Any of these actions may be supported through identification of container 100 by scanning passive identifier 117 and/or by interacting with active identifier 116 as an NFC tag, through app 132.

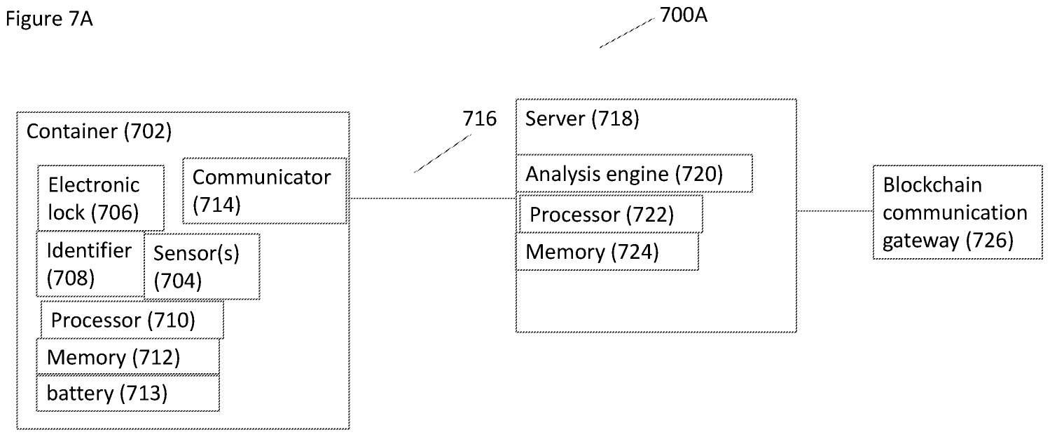

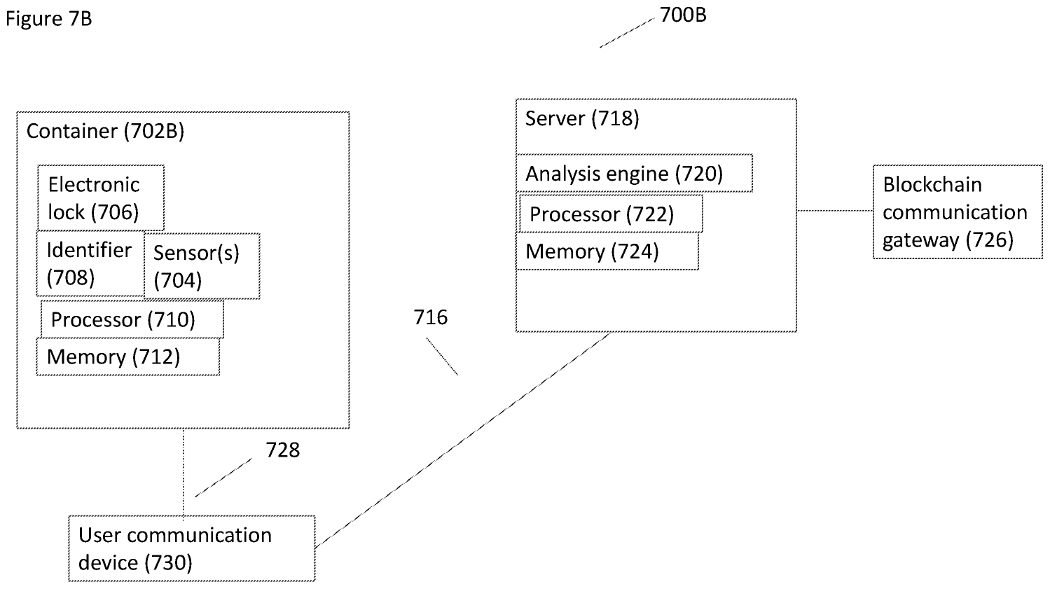

FIGS. 7A and 7B show non-limiting, exemplary, illustrative systems for tracking the state of the secure container. As shown with regard to FIG. 7A, a system 700A features a secure container 702 in communication with a server 718 through a computer network 716, which may for example comprise the Internet. Container 702 preferably features a plurality of sensors 704, which may comprise one or more of a temperature sensor, GPS tracking device, accelerometer, gyroscope, and IMU. The signal from GPS tracking device may be used for example to support geofencing, such that container 702 sends an alert and/or an alarm is signaled by another entity upon detecting that container 702 has moved out of a geofenced area. Sensors 704 provide information on the state of container 702, for example with regard to geographic location, temperature, relative geographic location, movement and also any forces to which container 702 has been subjected, including but not limited to rotation and acceleration.

Sensor signals are then transmitted to server 718, for example through computer network 716, through a communicator 714. Preferably, communicator 714 comprises a cellular network communication hardware device, which may for example authenticate itself for communication through the cellular network with a SIM card. An analysis engine 720 on server 718 then analyzes the sensor signals to determine the state of secure container 702.

Preferably the state of secure container 702 is recorded on a blockchain through a blockchain communication gateway 726. Data is stored and managed using blockchain technology, as supported by blockchain communication gateway 726. Optionally, the blockchain can run code. As is known in the art, blockchains can perform more complex operations, defined in full-fledged programming languages. However, it is not a requirement for the blockchain to run code in order for the present invention to be implemented. Optionally only a distributed ledger is required, in which information is written that is securely available to all parties through cryptographic access to the distributed ledger.

According to at least some embodiments the blockchain is optionally a public or permissionless blockchain, such as Bitcoin or Ethereum, which is decentralized and which is a blockchain that anyone in the world can read, anyone in the world can send transactions to and expect to see them included if they are valid, and anyone in the world can participate in the consensus process for determining what blocks get added to the chain and what the current state is. As a substitute for centralized or quasi-centralized trust, public or permissionless blockchains are secured by cryptoeconomics—the combination of economic incentives and cryptographic verification using mechanisms such as proof of work or proof of stake.

Alternatively and optionally, the blockchain is a consortium blockchain, such as Hyperledger, where the consensus process is controlled by a pre-selected set of nodes, which for example may optionally be provided or supported by financial institutions and/or by an international consortium of conservation and development organizations. Such a blockchain is partially decentralized.

Optionally, the Hyperledger Fabric blockchain framework implementation is used (details are provided in “Architecture of the Hyperledger Blockchain Fabric” by Christian Cachin, IBM Research—Zurich, July 2016). It is one of the Hyperledger projects hosted by The Linux Foundation. Intended as a foundation for developing applications or solutions with a modular architecture, Hyperledger Fabric allows components, such as consensus and membership services, to be plug-and-play. Hyperledger Fabric leverages container technology to host smart contracts called “chaincode” that comprise the application logic of the system. This framework also includes such features as:
Channels for sharing confidential information
Ordering Service delivers transactions consistently to peers in the network
Endorsement policies for transactions
CouchDB world state supports wide range of queries
Bring-your-own Membership Service Provider (MSP)

If the blockchain is private or permissioned—that is, centrally controlled by an operating entity to authorize participation—then optionally all members of the system as described by the present invention which need access are provided with cryptographic access, and become members of the private or permissioned blockchain system, such as Hyperledger.

Hyperledger has its own set of protocols and consensus process, which may optionally be used with smart contracts, to prevent fraud through rewriting information.

One of ordinary skill in the art could easily select a distributed ledger and implement it within various embodiments of the present invention, for example according to information provided in “Blockchain Basics: Introduction To Business Ledgers” by Brakeville and Perepa, IBM, May 9, 2016.

For all of these examples, security for the blockchain may optionally and preferably be provided through cryptography, such as public/private key, hash function or digital signature, as is known in the art.

Container 702 also preferably comprises an electronic lock 706 and an identifier 708. Identifier 708 enables an authorized individual to gain access to the contents of container 702 by unlocking electronic lock 706. Electronic lock 706 preferably only opens upon receipt of a signal indicating that an authorized recipient wishes to access the contents. Such a signal may be provided for example through one or more of an NFC ID card reader, biometric sensor, communication with a smart device, entry of a code and/or remote transmission of an unlocking signal. Optionally identifier 708 supports provision of such a signal, for example by comprising NFC ID card reader, biometric sensor, code entry device, remote transmission validation device and the like.

The biometric sensor may comprise for example one or more of fingerprint, palmprint, voice analysis, retinal scan, iris scan and/or facial identification. Optionally each such container 702 has a unique serialized QR code. Scanning the QR code on container 702 may be used to initiate unlocking, optionally followed by one or more of, through an NFC card reader signal, biometric sensor signal, communication with a smart device, entry of a code and/or remote transmission of an unlocking signal. Some combination of these methods may also be used.

Identifier 708 may receive information about a particular individual opening and/or closing container 702. Such an individual may be identified as a specific person, for example if biometric identification is used. In this case, the fingerprint, palmprint, voice analysis, retinal scan, iris scan and/or facial identification for the specific person would be associated with container 702 such that only the specific person with that biometric identifier(s) may be permitted to open and/or close container 702. Alternatively or additionally, identifier 708 may be associated with a particular role, for example a permitted individual with an ID card, entering a code and/or operating a remote transmission validation device.

The permitted individual and/or role may be associated with the ability to open and/or close container 702 through communication between container 702 and server 718. For example, the identity of a specific person and/or of a particular role may be transmitted to server 718. By “identity” it is meant at least information that is necessary to provide to container 702 to permit container 702 to be opened by that specific person and/or person having a particular role. In the case of a code to be entered for example, the code may be set by server 718 and then sent to one or more individual(s) opening or at least capable of opening container 702. For operating a remote transmission validation device and/or providing an NFC ID card, optionally server 718 may set such a capability remotely for container 702. Biometric information may also be sent from server 718 to container 702. Alternatively or additionally, any such information and/or capabilities may be determined locally at container 702.

Communication with blockchain communication gateway 726 may involve execution of one or more smart contracts (not shown). For example a smart contract may execute if the state of container 702 exceeds one or more permitted boundaries. Optionally execution of the smart contract causes server 718 to execute an alarm. Optionally, alternatively or additionally, the smart contract executes if the state of container 702 stays within one or more permitted boundaries during a specified period. For example, such a specified period corresponds to shipment of a product contained within container 702. In this case, the smart contract may execute to indicate that one or more conditions required for successful shipment of container 702 have been fulfilled.

Container 702 preferably also features a processor 710 and a memory 712. Functions of processor 710 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 712 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Preferably, processor 710 and memory 712 are configured as part of a SOC (system on chip) and/or other microprocessor architecture, more preferably one which is low power or will otherwise not draw excessive power from a battery 713.

Also optionally, memory 712 is configured for storing a defined native instruction set of codes. Processor 710 is configured to perform a defined set of basic operations in response to receiving a corresponding basic instruction selected from the defined native instruction set of codes stored in memory 712. For example and without limitation, memory 712 may store a first set of machine codes selected from the native instruction set for receiving signals from one or more sensor(s) 704; a second set of machine codes selected from the native instruction set for transmitting such signals to server 718 through communicator 714; and a third set of machine codes selected from the native instruction set for controlling a state of electronic lock 706 as open or closed. Optionally memory 712 may store a fourth set of machine codes selected from the native instruction set for controlling a state of electronic lock 706 according to one or more signals received through identifier 708, which may indicate whether an authorized user has requested to change the state of electronic lock 706 to open or closed.

Similarly, server 718 preferably also features a processor 722 and a memory 724, with machine readable instructions with related or at least similar functions, including without limitation functions of server 718 as described herein. For example and without limitation, memory 724 may store a first set of machine codes selected from the native instruction set for receiving sensor signals from container 702, a second set of machine codes selected from the native instruction set for executing functions of analysis engine 720, and a third set of machine codes selected from the native instruction set for transmitting information about the state of container 702 to blockchain communication gateway 726.

FIG. 7B shows a different exemplary implementation of a system for tracking a secure container. Components with the same reference numbers as FIG. 7A have the same or at least similar functions. As shown in a system 700B, a container 702B comprises a number of components of container 702 of FIG. 7A. However, container 702B lacks a separate communicator in this exemplary implementation. Instead, communication of sensor signals and other information from, as well as incoming signals to, container 702B is supported by a user communication device 730. Container 702B preferably communicates with user communication device 730 through wired and/or wireless communication channel 728.

User communication device 730 in turn communicates with server 718 through computer network 716, to relay sensor signals and other information from, as well as incoming signals to, container 702B.

Optionally container 702B lacks a battery as well as shown. Alternatively and optionally a battery is present, as for FIG. 7A (not shown).

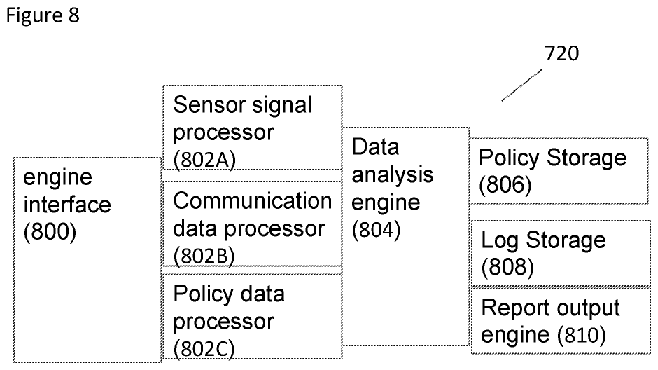

FIG. 8 shows a non-limiting, exemplary, illustrative analysis engine for the systems of FIGS. 7A and 7B. As shown, analysis engine 702 preferably features an engine interface 800 for receiving information from the server and transmitting an analysis and/or other signals to the server (not shown) Analysis engine 702 preferably comprises a plurality of processors 802, shown as sensor signal processor 802A, communication data processor 802B and policy data processor 802C for the purpose of illustration only and without any intention of being limiting. Engine interface 800 preferably receives signals from one or more sensors on the container (not shown), which are then processed by sensor signal processor 802A. Engine interface 800 preferably receives other communication from the container (not shown), which are then processed by communication data processor 802B. Policy information may be retrieved from a policy storage 806 and/or may be transmitted through engine interface 800; in either case, the policy information is preferably analyzed by policy data processor 802C.

The various types of processed information are preferably then passed to a data analysis engine 804, which analyzes the information to determine at least the state and/or location of the container. Data analysis engine 804 may also determine whether an alert or an alarm should be issued, for example because the state and/or location of the container are not within norms or limits that are determined according to policy information processed by policy data processor 802C. For example and without limitation, data analysis engine 804 may determine that the container is no longer within a geofenced area; and/or that the container is no longer present in an environment of the correct standards, for example and without limitation according to temperature, humidity and/or acceleration data.

Data analysis engine 804 may also determine that an unauthorized user is attempting to open the container, and/or that an authorized user has successful requested a change in the state of the container to open or closed, for example through communication through the identifier which has led to a change of state of the electronic lock.

The determinations of data analysis engine 804 may be stored in a log storage 808 and/or output through a report output engine 810.

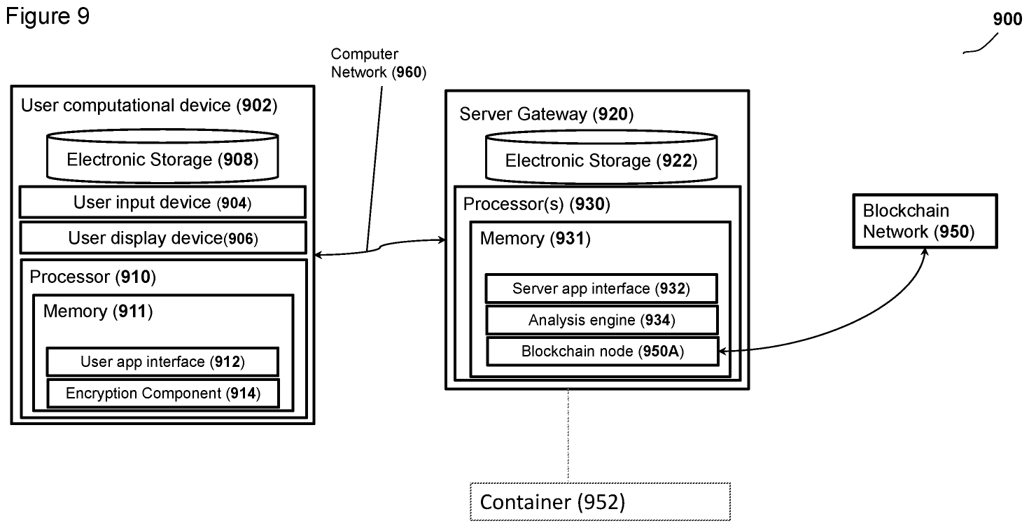

FIG. 9 shows a non-limiting, exemplary, illustrative system for supporting communication with a user computational device. As shown in a system 900, a user computational device 902 communicates with a server gateway 920 through a computer network 960. In this implementation, server gateway 920 supports direct reading information from, and storing information on, a blockchain network 950. Server gateway 920 communicates with a container 952, which may for example be implemented according to any of the container implementations described herein. Container 952 is preferably able to communicate its state, including without limitation through signals from one or more sensors (not shown) to server gateway 920. Such communication may be provided through a direct communication channel and/or indirectly.

Server gateway 920 preferably analyzes such communication and then writes the state of container 952 to blockchain network 950. Server gateway 920 may for example read information from and write information to blockchain network 950 through a blockchain node 950A, and/or through a blockchain gateway (not shown). Server gateway 920 may also transmit the state of container 952 to user computational device 902, for example to indicate an alarm and/or to indicate changes in the state over time.

User computational device 902 optionally includes the user input device 904, the user app interface 912, and user display device 906. User input device 904 may optionally be any type of suitable input device including but not limited to a keyboard, microphone, mouse, or other pointing device and the like. Preferably user input device 904 includes a microphone and a keyboard, mouse, or keyboard mouse combination.

User computational device 902 also preferably comprises a processor 910 and a memory 911. Functions of processor 910 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 911 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 911 is configured for storing a defined native instruction set of codes. Processor 910 is configured to perform a defined set of basic operations in response to receiving a corresponding basic instruction selected from the defined native instruction set of codes stored in memory 911. For example and without limitation, memory 911 may store a first set of machine codes selected from the native instruction set for receiving information from the user through user app interface 912 and a second set of machine codes selected from the native instruction set for transmitting such information to server gateway 920 as user instructions.

Similarly, server gateway 920 preferably comprises processor 930 and memory 931 with machine readable instructions with related or at least similar functions, including without limitation functions of server gateway 920 as described herein. For example and without limitation, memory 931 may store a first set of machine codes selected from the native instruction set for receiving instructions from user computational device 902, a second set of machine codes selected from the native instruction set for executing functions of analysis engine 934, a third set of machine codes selected from the native instruction set for transmitting information about the state of container 952 to user computational device 902 and a fourth set of machine codes selected from the native instruction set for storing information about the state of container 952 on blockchain network 950.

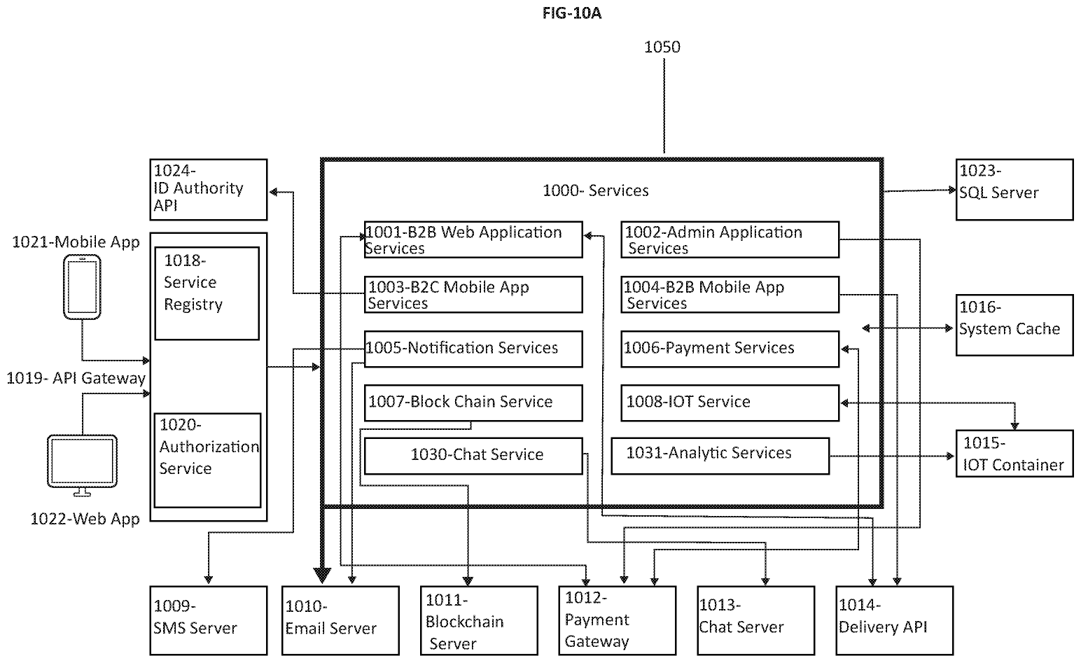

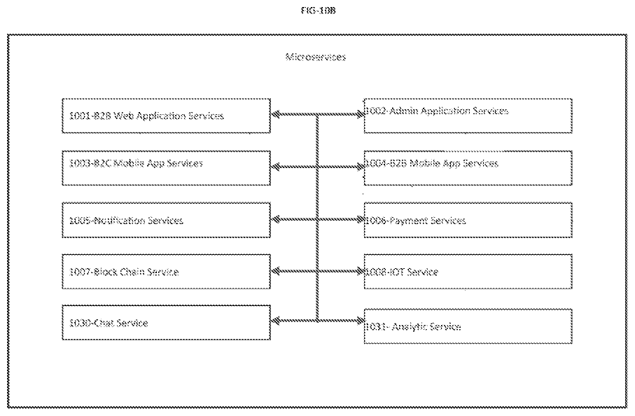

FIG. 10A shows a non-limiting, exemplary, illustrative system for supporting communication with multiple devices. As shown in a system 1050, a plurality of services 1000 support various functions as shown herein. Services 1000 may for example be configured as microservices and/or with regard to a server as described herein. Services 1000 preferably include a B2B Web Application Services 1001, for supporting communication with one or more businesses using the traceable end to end delivery services as described herein. For example and without limitation, B2B Web Application Services 1001 preferably communicates with a payment gateway 1012 and also with a delivery API 1014. Payment gateway 1012 preferably also communicates with delivery API 1014 and with a chat server 1013 as shown. Admin Application Services 1002 also preferably communicate with payment gateway 1012. B2B Web Application Services 1001 may also support one or more requirements such as authentication of a company license or other registration information, for example as part of the authentication and/or end to end traceability process.

B2C Mobile App Services 1003 supports communication with one or more consumers using the traceable end to end delivery services as described herein, in this non-limiting example as a consumer, including without limitation checking the authenticity of a product, placing a new order, receiving information from the manufacturer, and tracing the shipment. Business users may also use B2C Mobile App Services 1003 to manage shipments, containers and deliveries, to check the authenticity of products and make sure that all received products are compliant. B2C Mobile App Services 1003 preferably communicate with an ID Authority API 1024, for example to support identification of a specific container and/or of a particular consumer recipient of a safe container as described herein. Information may be received from the container and then passed through ID Authority API 1024. B2C Mobile App Services 1003 then determines whether the container has been correctly identified and sends this determination back to ID Authority API 1024.

Notification Services 1005 receive an alarm, alert and/or other notification, for example as determined according to sensor signal analysis from the container (not shown), and then determines whether a notification should be transmitted. If so, then such a notification is preferably transmitted to an SMS server 1009 for example, for transmitting an SMS as a notification; and/or such a notification may be transmitted to an email server 1010 for example, for transmitting an email as a notification.

A Block Chain Service 1007 preferably causes information about the container, such as for example its state and/or location, to be recorded through a blockchain server 1011.

B2B mobile app service 1004 preferably communicates the state and/or location of the container, and/or provide identification for locking and/or unlocking the container, to a delivery API 1014, after which the information may be transmitted through one or more servers and/or to one or more devices (not shown).

Payment Services 1006 preferably communicates with payment gateway 1012, to support a connection between payment for a shipment, a container and/or a product.

An IOT Service 1008 preferably supports communication with one or more IoT devices and/or containers 1015, such as for example one or more sensors and/or safe containers as described herein. A chat service 1030 enables the user to chat with an AI or other simple chatbot through a chat server 1013.

An API gateway 1019 preferably supports communication with a mobile app 1021 and/or a web app 1022, and also with services 1000. API gateway 1019 preferably comprises a service registry 1018 for supporting communication between services 1000 and mobile app 1021 and/or web app 1022. API gateway 1019 also preferably comprises an authorization service 1020 for authorizing such communication. For example and without limitation, mobile app 1021 and/or web app 1022 may not be authorized to access each service of services 1000 and/or may not be authorized to access all data available through services 1000. Mobile app 1021 and/or web app 1022 may be used to show information about one or more containers for a manufacturer, shipper and/or other logistics manager, and/or a recipient, including without limitation location, state of the container, estimated arrival time, whether the state of the container has been out of bounds of one or more parameters, payment status and so forth. Such information may be obtained through services 1000 for example, and/or any of the other services as shown herein. The recipient may be a commercial or a consumer recipient.

Mobile app 1021 and/or web app 1022 may be used to create a unique tracing code for a particular container, such as a QR code for example. Mobile app 1021 and/or web app 1022 may also be used to associate the type of authentication required for a particular shipment, which would then determine the type of authentication required for a particular container. In some cases, this requirement may in turn determine which physical container may be used, as for example if the manufacturer and/or shipper requires biometric authentication to open the container, then the container would need to have such biometric authentication capabilities.

Services 1000 may also communicate with a system cache 1016 and/or with an SQL server 1023, for data storage and/or retrieval for example.

FIG. 10B shows exemplary, non-limiting communication between services in such a system. Services with the same reference numbers as in FIG. 10A have the same or at least similar function. As shown, microservices 1000 may feature communication within such services. Optionally and preferably each such service is able to communicate with each such other service, whether directly or through an interface. Such communication may be supported for a variety of functions. For example, B2B Web Application Services 1001 may communicate with B2C Mobile App Services 1003, to support end to end traceability and/or to handle such services as payment. Similarly, B2B Mobile App Services 1004 preferably communicates with B2B Web Application Services 1001, to support shipment and tracing of the container. B2B Web Application Services 1001 may act as a central “director” of the microservices as shown, also communicating with all services as shown.

An analytic service 1031 is preferably provided to analyze sensor signals and optionally to determine when such signal(s) show that the state of the container is out of one or more bounds.

B2B Web Application Services 1001 preferably communicates with blockchain service 1007 to read information from, and optionally to write information to, blockchain service 1007. Analytic service 1031 may also communicate with blockchain service 1007, for example to read information from and/or to write information to blockchain service 1007. For example and without limitation, blockchain service 1007 may store information regarding the state of the container which may be required for determining whether the current state of the container is out of one or more bounds.

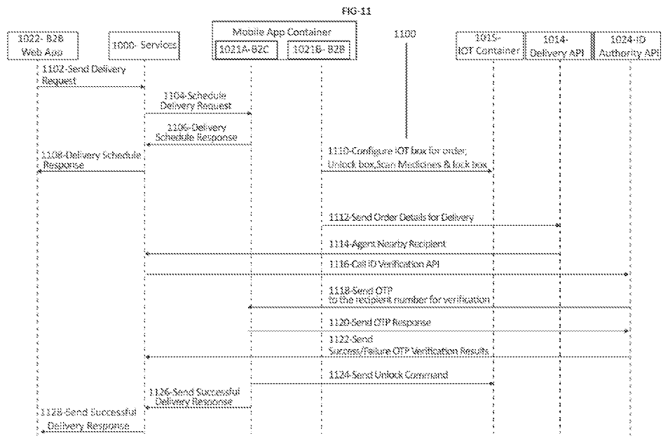

FIG. 11 shows a non-limiting, exemplary, illustrative method for communication between multiple devices. As shown in a method 1100, communication between web app 1022, services 1000, container 1015, delivery API 1014, ID authority API 1024, and a mobile app container application which includes B2C mobile app 1021A and B2B mobile app 1021B. Optionally B2C mobile app 1021A and B2B mobile app 1021B communicate with each other and/or with components as shown herein interchangeably.

The method begins with a delivery request being sent at 1102 from web app 1022 to services 1000. Then a delivery schedule request is sent from services 1000 to B2C mobile app 1021A, so that a date and optionally also time for the delivery can be scheduled. B2C mobile app 1021A returns a response to services 1000 at 1106 to schedule the delivery. This scheduling information is then sent to web app 1022 at 1108. Optionally and preferably, B2C mobile app 1021A and B2B mobile app 1021B communicate with each other regarding the delivery information.

At 1110, B2B mobile app 1021B sends configuration information to container 1015; then supports container 1015 being opened, the product(s) being placed inside and then locking container 1015. At 1112, order details for the delivery are sent to delivery API 1014. At 1114, delivery API 1014 then determines which delivery agent may be used to fulfill the order and sends this information to services 1000. Services 1000 then requests identification verification at 1116 from ID authority API 1024.

At 1118, ID authority API 1024 preferably sends an OTP (one time password) or other verification information to B2C mobile app 1021A. A response is then sent at 1120, which is verified and the verification results returned to services 1000 at 1122. B2C mobile app 1021A may then send the unlock command at 1124 to container 1015. B2C mobile app 1021A then transmits a successful delivery indicator at 1126 to services 1000. Services 1000 then preferably transmits the successful delivery indicator at 1128 to B2B mobile app 1021B.

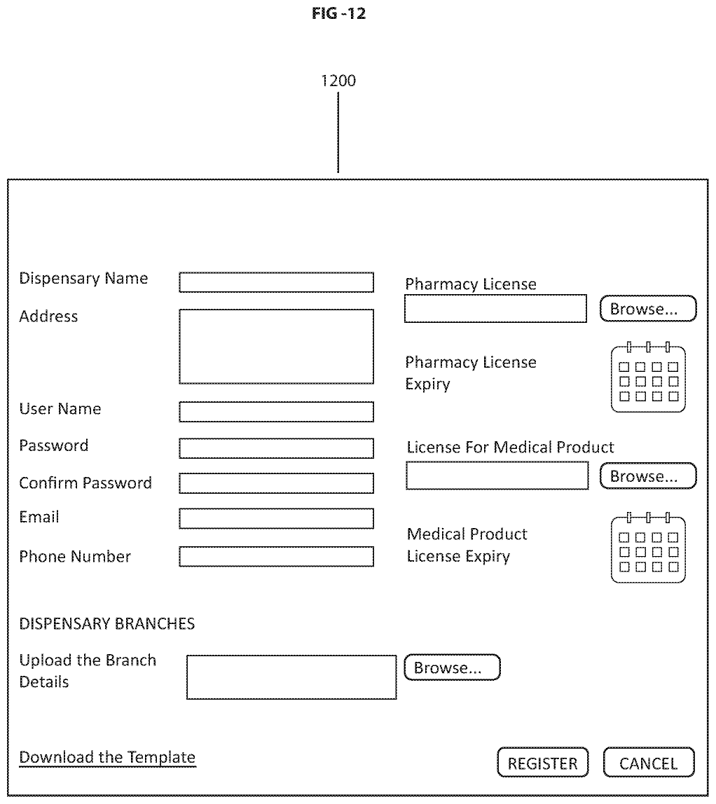

FIG. 12 shows a non-limiting, exemplary, illustrative order display screen, in this non-limiting example for a medical product. As shown on a screen 1200, the user may be required to fill such information as a medical license, a license for the product itself, contact and/or location details for the dispensary or other authorized issuer of such medical products; and the like.

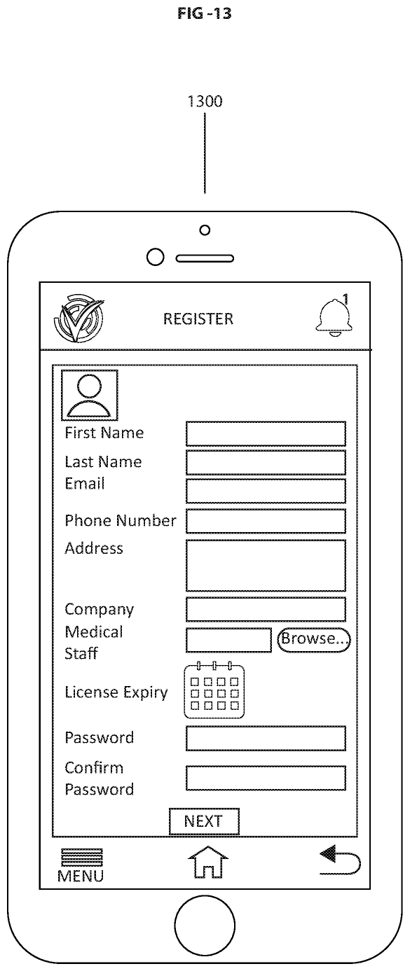

FIG. 13 shows a non-limiting, exemplary, illustrative registration screen. As shown on a screen 1300, a new user may be required to fill in identification information, including for example their contact information, any license or authorization information, a password and so forth. Optionally when a company registers or after registration, the company may decide to register particular brands with the service. Such a brand based registration may be used for example to support traceability of product(s) associated with that brand. The company may also organize product(s) by category for each brand, optionally within a product category, for simpler arrangement of traceable transport.

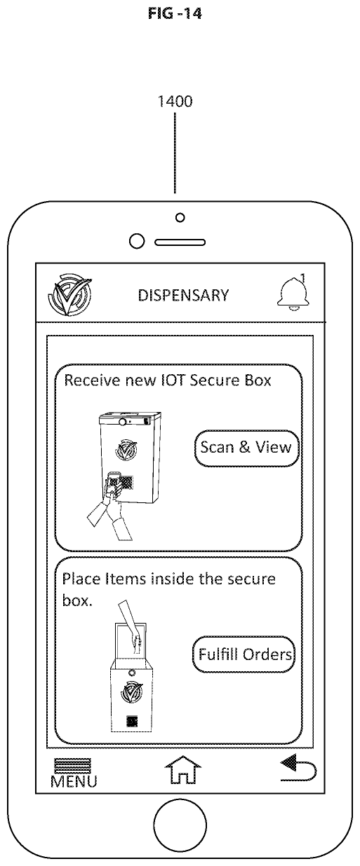

FIG. 14 shows a non-limiting, exemplary, illustrative screen for preparing a new order. As shown on a screen 1400, the user is guided through the process of preparing a new order, including identifying a specific container and then placing one or more products within the container.

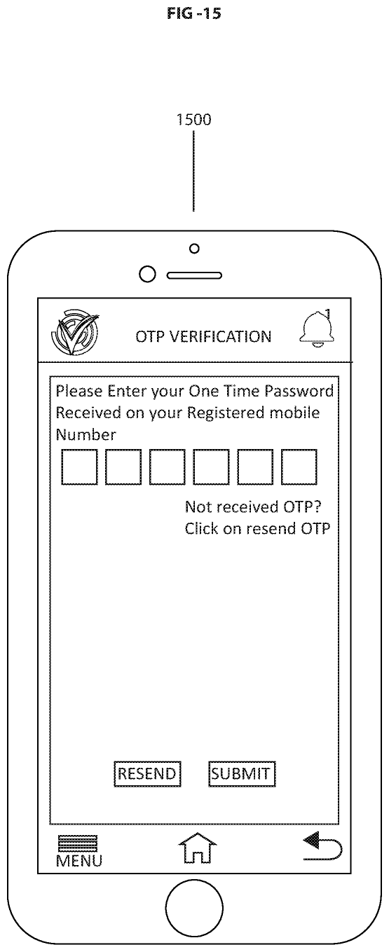

FIG. 15 shows a non-limiting, exemplary, illustrative screen for authenticating a user. As shown on a screen 1500, the user is asked to enter a OTP (one time password) for authentication, as a non-limiting example of such authentication.

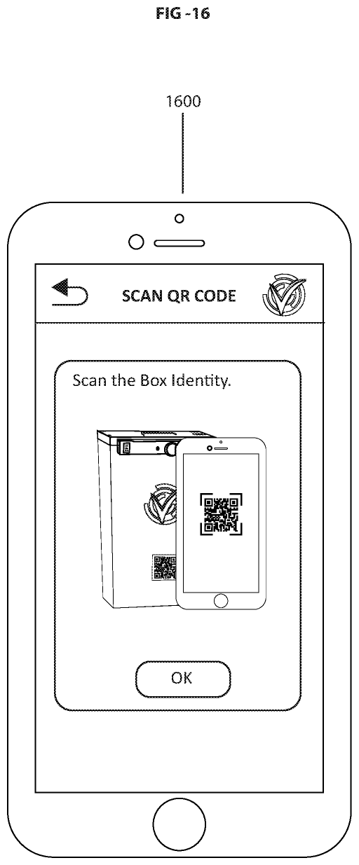

FIG. 16 shows a non-limiting, exemplary, illustrative screen for identifying a specific container. As shown on a screen 1600, the user is requested to scan the QR code or other passive identifier of the container, as a non-limiting example of such container identification.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A system for providing traceability, comprising a safe delivery container with a traceable state, comprising a space for holding a product;
a sensor for providing signals regarding a state of the container; a communication module for communicating said signals; and a security device for securing the container; a distributed ledger technology (DLT) for recording said state of said container; and a server for receiving such signals from said communication module and for determining said state according to said signals, and for recording said state on said DLT; wherein said security device comprise an electronic smart lock; wherein said container comprises a lid, a plurality of walls and a floor, wherein said space is defined by said lid, said plurality of walls and said floor; wherein said security device comprises said electronic lock for securing said lid to at least one wall.

2. The system of claim 1, wherein said sensor comprises one or more of a temperature sensor, GPS tracking device, accelerometer, gyroscope, and an IMU.

3. The system of claim 1, wherein said communication module comprises a cellular communication device; wherein said cellular communication device comprises a SIM card.

4. (canceled)

5. The system of claim 3, further comprising a local communication device, wherein said container is brought into communication contact with said local communication device; wherein said local communication device comprises one or more of a mobile communication device or a near field communication (NFC) device.

6. (canceled)

7. (canceled)

8. The system of claim 1, wherein said electronic smart lock opens upon receipt of a signal indicating that an authorized recipient wishes to access said container.

9. The system of claim 8, wherein said signal comprises an authorization code and said security device comprises a code entry device for receiving said authorization code.

10. (canceled)

11. The system of claim 1, wherein said signal comprises a remote authorization signal received through said communication module.

12. The system of claim 11, further comprising a user app and a user computational device for operating said user app, wherein said remote authorization signal is sent through said user app.

13. The system of claim 12, wherein said user computational device communicates with said server for determining authorization of said user app and for sending said remote authorization signal.

14. The system of claim 12, wherein said signal comprises an NFC ID card signal and said security device further comprises an NFC ID card reader for receiving said signal; or wherein said signal comprises a biometric signal and said security device further comprises a biometric sensor for receiving said signal.

15. (canceled)

16. The system of claim 14, wherein said biometric sensor comprises one or more of fingerprint, palmprint, voice analysis, retinal scan, iris scan and/or facial identification.

17. The system of claim 1, wherein said container comprises an external visual code and said signal comprises an authenticated scan of said external visual code.

18. (canceled)

19. (canceled)

20. (canceled)

21. (canceled)

22. The system of claim 1, wherein said security device comprises an identification device for generating and/or receiving said authentication signal, and said identification device is set into said lid.

23. The system of claim 22, wherein said lid further comprises said sensor(s) and said communication module.

24. The system of claim 23, wherein said lid is capable of being added to a suitable container construction comprising four walls and a floor.

25. The system of claim 1, wherein said lid further comprises a motherboard, wherein said identification device and a plurality of said sensors for providing signals regarding a state of the container are located on or in communication with said motherboard, said motherboard further comprising a SOC (system on chip), said SOC comprising a processor and a memory, said memory comprising a plurality of instructions for being executed by said processor and for supporting one or more functions of said container.

26. The system of claim 1, wherein said DLT comprises a blockchain; the system further comprising a blockchain gateway, wherein said blockchain gateway is in communication with said server for reading from and writing to said blockchain.

27. (canceled)

28. (canceled)

29. (canceled)

30. The system of claim 26, wherein said blockchain further comprises a smart contract, wherein said smart contract executes if said state of said container exceeds one or more permitted boundaries; wherein execution of said smart contract causes said server to execute an alarm.

31. (canceled)

32. The system of claim 26, wherein said blockchain further comprises a smart contract, wherein said smart contract executes if said state of said container stays within one or more permitted boundaries during a specified period.

33. The system of claim 32, wherein said specified period corresponds to shipment of a product contained within said container.

34. The system of claim 26, wherein said server receives signals from said sensor and determines whether said state of said container exceeds one or more permitted boundaries.

35-42. (canceled)
